(19) United States
(12) Patent Application Publication
(10) Pub. No.: US 2005/0125379 A1
(43) Pub. Date: Jun. 9, 2005

(54) Module management device and module management system and method using the same

(76) Inventors: In-sung Choi, Seoul (KR); Jung-soo Seo, Suwon-si (KR)

Correspondence Address: STANZIONE & KIM, LLP, 1740 N STREET, N.W., FIRST FLOOR, WASHINGTON, DC, 20036, US

(21) Appl. No.: 10/992,685

(22) Filed: Nov. 22, 2004

(30) Foreign Application Priority Data
Dec. 5, 2003 (KR) 2003-88192

(51) Int. Cl. G06F 7/00

(52) U.S. Cl. 707/1

(57) ABSTRACT

A module management device and module management system and method using the same to manage a module mounted in a terminal in which a browser is installed, include a detection unit to detect an operation state of the module, a file creation unit to create an information file including the specification information and the operation state of the module, a file storage unit to store the created information file, and a control unit to control the detection unit to detect the operation state according to the specification information, and to connect the browser to a web server providing a web site relating to the module if the detection unit detects a malfunction state of the module, to control the browser to automatically transfer to the web server the information file stored in the file storage unit if there is a request from the web server, and to control the web server to receive a web page based on the information file.

### CROSS-REFERENCE TO RELATED APPLICATIONS

This application claims benefit under 35 U.S.C. § 119 from Korean Patent Application No. 2003-88192, filed on Dec. 5, 2003, the entire content of which is incorporated herein by reference.

### BACKGROUND OF THE INVENTION

1. Field of the Invention

The present general inventive concept relates to a module management device to directly access a desired web page from a web server providing the web site relating to a module installed in a terminal, such as a personal computer (PC), and more particularly, to a module management system and method using a module management device to directly access a desired web page from a web server providing a web site relating to a module installed in a terminal, such as a personal computer (PC).

2. Description of the Related Art

In recent, as active electronic commerce through the Internet shopping rapidly spreads, most manufactures, wholesales, and retailers of terminals, such as PCs or their peripheral devices, sell PC peripherals, parts, consumables, and so on, through the Internet shopping.

In addition, it is general to build and use a system automatically judging whether the peripheral devices, such as printers, have been out of order or whether consumables, such as cartridges, have been run out, and managing logging on to web sites of the manufactures, wholesales, and retailers of the corresponding devices and consumables which are out of order or run out.

Hereinafter, description will be made on a system managing modules, such as peripherals or consumables. FIG. 1 is a view illustrating a structure of a conventional module management system.

In FIG. 1, the module management system is structured to connect a terminal, such as a PC 10, to a web server 30 through the Internet 20.

The PC 10 has a web browser 11, a control unit 13, a monitoring unit 15, and a module 17. If the monitoring unit 15 monitors whether the module 17 is in a malfunction state or a run-out state, the control unit 13 controls the web browser 11 to log on to a home page of at least one of a manufacturer, a wholesaler, and a retailer of the module 17. The web server 30 provides the home page to the web browser 11 through the Internet 20.

FIG. 2 is a flow chart illustrating a module management method of the module management system shown in FIG. 1.

Referring to FIGS. 1 and 2, a monitoring unit 15 monitors whether the module 17 is in the malfunction state or the run-out state (S61). If the monitoring unit 15 checks that the module 17 is in the malfunction or run-out state (S63), the web browser 11 accesses the home page of the manufacturer, the wholesaler, and the retailer of the module 17. The web server 30 provides the home page to the web browser 11 through the Internet 20 (S65).

Hereinafter, after moving to a product sale web page provided in the logged-on home page, a user searches for a module corresponding to the module 17 in problem (in the malfunction or run-out state) (S67) and purchases the module 17 (S69).

As stated above, the conventional module management system looks for the home page of the manufacturer, the wholesaler, and the retailer and attempts to log on to a product sales web page of the home page. In addition, the user is required to separately input a product name, a product number, and so on, of the module 17 on the product sales web page, and searches for the module 17 that the user wishes to purchase, which causes inconvenience. It is more inconvenient to the user that the manufacturer, the wholesaler, and the retailer have different home pages in structure. In particular, it is much more inconvenient to the user when the user is unfamiliar with purchasing products through the Internet. Further, if the user does not have information on the product name, the product number, and so on, this causes a problem that it is impossible to search for the right product.

### SUMMARY OF THE INVENTION

In order to solve the foregoing and/or other problems, it is an aspect of the present general inventive concept to provide a module management device and a module management system and method using the same that can detect specification information and an operation state of a module installed in a terminal, such as a PC, and can directly obtain a right web page of a web server providing a web site relating to the module using an information file, such as a cookie file, created based on the detection of the specification information and the operation state of the module.

Additional aspects and advantages of the present general inventive concept will be set forth in part in the description which follows and,in part, will be obvious from the description, or may be learned by practice of the general inventive concept.

The foregoing and other aspects and advantages of the present general inventive concept may be achieved by providing a module management device to manage a module mounted in a terminal in which a browser is installed, the module management device comprising a detection unit to detect an operation state of the module, a file creation unit to create an information file including the specification information and the operation state of the module, a file storage unit to store the created information file, and a control unit to control detection operations of the detection unit by referring to the specification information, to connect the browser to a web server providing a web site relating to the module when the detection unit detects a malfunction of the module and to control the browser to automatically transfer to the web server the information file stored in the file storage unit if there is a request of the web server, and to receive a web page provided by the web server based on the information file. In an aspect of the present general inventive concept, the information file may be a cookie file.

In another aspect of the present general inventive concept, the detection unit can detect the specification information of the module, and the file creation unit can create the information file including the specification information detected in the detection unit.

In yet another aspect of the present general inventive concept, the module management device may further comprise a display unit to display at least one of the specification information, the operation state, and a certain web page relating to the module.

In still another aspect of the present general inventive concept, the specification information can include a replacement period of time of the module, and the control unit can set a detection period of time of the detection unit according to the replacement period of time and can control detection operations of the detection unit according to the set detection period of time.

In another aspect of the present general inventive concept, the web server can send to the browser a module purchase web page provided from the home page of the web site relating to the module if the operation state of the information file received by the web server indicates that the module is in a malfunction state since the module is run out.

The foregoing and/or other aspects of the present general inventive concept may also be achieved by providing a module management system comprising a module management device to create an information file including in specification information and an operation state of a module mounted in a terminal and to connect a browser installed in the terminal to a web site relating to the module if the module is detected to be in a malfunction state or in a run-out state, and a web server to request the browser to send the information file, and to send to the module management device through the browser a certain web page provided from a home page of the web site relating to the module. In an aspect of the present general inventive concept, the information file may be a cookie file.

In another aspect of the present general inventive concept, the module management device may include a detection unit to detect the operation state of the module, a file creation unit to create the information file, a file storage unit to store the created information file, and a control unit to control the detection unit to detect the operation state of the module by referring to the specification information and to control the browser to be connected to the web server if the detection unit detects the malfunction of the module.

In yet another aspect of present general inventive concept, the module management device may include a display unit to display at least one of the specification information, the operation state, and a certain web page relating to the module.

In still another aspect of the present general inventive concept, the web server may include a web page storage unit to store a home page of a web site relating to the module and web pages provided in the home page, and a search unit to decide the certain web page to be sent to the module management device by referring to the information file, and to search the web page storage unit for the web page decided to be sent.

In another aspect of the present general inventive concept, the search unit may decide sending of a module purchase web page provided from the home page of the web site relating to the module if the operation state included in the information file indicates the malfunction state of the module since the module is run out.

The foregoing and/or other aspects of the present general inventive concept may also be achieved by providing a module management method of a module management system having a module management device to detect a malfunction state of a module mounted in a terminal and a web server to provide a web site relating to the module, the module management comprising detecting an operation state of the module in the module management device, creating an information file including specification information and the operation state of the module in the module management device, automatically sending the information file to the web server if the module management device detects a malfunction state of the module, and sending a certain web page to the module management device by the web server referring to the information file. In an aspect of the present general inventive concept, the information file is a cookie file.

In another aspect of the present general inventive concept, the detecting of the operation state of the module may detect the specification information of the module.

In another aspect of the present general inventive concept, the module management method can further comprise displaying at least one of the specification information, the operation state, and the certain web page.

In another aspect of the present general inventive concept, the specification information may include a replacement period of time of the module, and the detecting of the operation state of the module may detect the operation state of the module according to a detection period of time set based on the replacement period of time.

In another aspect of the present general inventive concept, the web server can send to the module management device a module purchase web page provided from the home page of the web site relating to the module if the operation state included in the information file received by the web server indicates that the module is in the malfunction state since the module is run out.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a structure of a conventional module management system;

FIG. 2 is a flow chart illustrating a module management method using the module management system shown in FIG. 1;

FIG. 3 is a block diagram illustrating a module management device according to an embodiment of the present general inventive concept;

FIG. 4 is a flow chart illustrating a module management method of the module management device shown in FIG. 3 according to another embodiment of the present general inventive concept;

FIG. 5 is a block diagram illustrating a module management system configured with the module management device shown in FIG. 3 according to another embodiment of the present general inventive concept; and

FIG. 6 is a flow chart illustrating a module management method of the module management device shown in FIG. 5 according to another embodiment of the present general inventive concept.

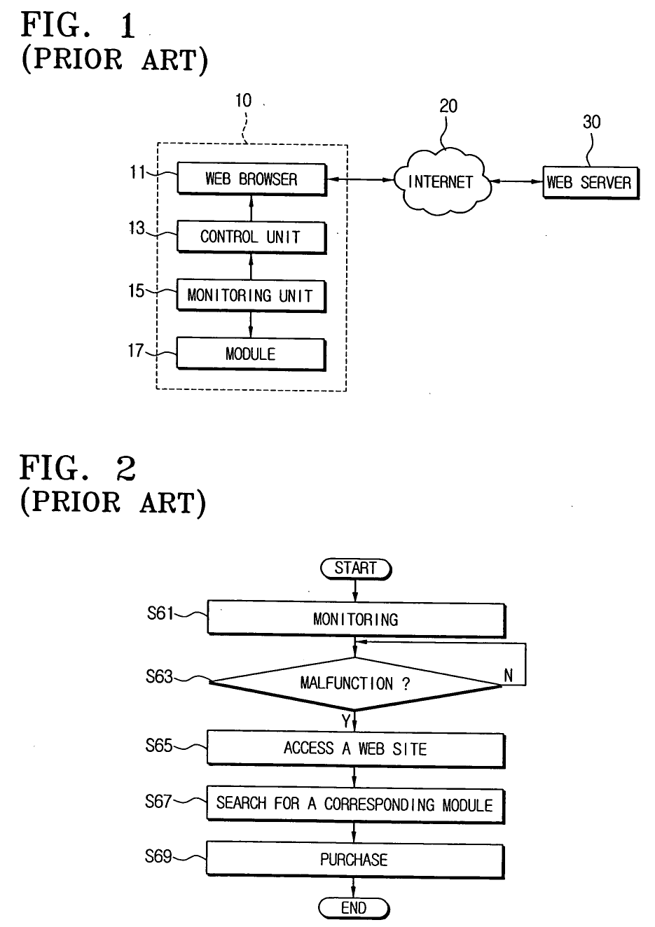

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

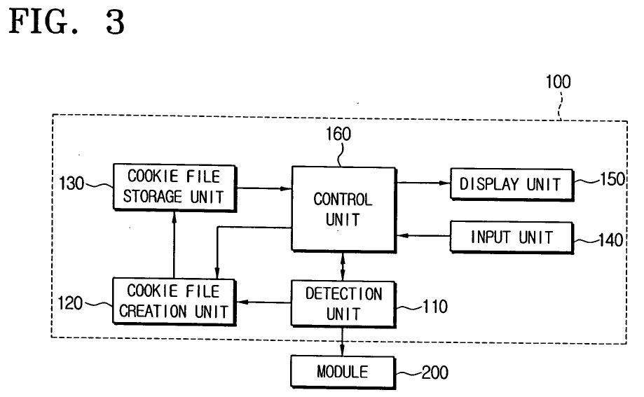

FIG. 3 is a block diagram illustrating a module management device 100 according to an embodiment of the present general inventive concept. For the purpose of easy understanding, FIG. 3 shows that the module management device 100 can be installed in a terminal, such as a PC, and a module 200 can also be provided in the terminal. If the module 200 is disposed outside the terminal, the module 200 can be connected to the terminal through a wire or wireless connection.

The module 200 provided in the terminal may be a peripheral device, such as a printer, scanner, etc., and consumables, such as a printer toner, an ink cartridge, etc.

The module management device 100 can detect specification information and an operation state of the module 200 and can create a cookie file which is a kind of an information file based on such detected information. The module management device 100 may have a detection unit 110, a cookie file creation unit 120, a cookie file storage unit 130, an input unit 140, a display unit 150, and a control unit 160.

The detection unit 110 can detect the specification information and the operation state of the module 200 under the control of the control unit 160.

The specification information of the module 200 can include information on the module 200, such as a product number, a replacement period of time, and so on, and can also include information relating to a user using the module 200, such as the number of times that the user uses the module 200 and so on.

The operation state of the module 200 can include information on whether the module 200 currently operates in a normal state or not. Further, if the module 200 is one of consumables, information on a malfunction state or a run-out state of the module 200 may be included in the operation state of the module 200.

The cookie file creation unit 120 can create a cookie file including the specification information and the operation state of the module 200 detected by the detection unit 110. A plurality of cookie files can be created depending on a type of a web site relating to the module 200. For example, if a web site relating to the peripherals and a web site relating to the consumables are not the same, the cookie file creation unit 120 can create the cookie files corresponding to respective ones of the web sites.

The cookie file can be a stored information file that is created by a browser based on data transferred from a web server and later sent by the browser to the web server if there is an additional request from the web server. If the web server receives the cookie file, the web server can decide a web page to be sent to the browser based on the content recorded in the cookie file. Further, the cookie file can include user information, last access date, a path, a domain name, and so on.

The cookie file storage unit 130 can be a storage medium to store cookie files created by the cookie file creation unit 120. The cookie file storage unit 130 may be a storage medium, such as a hard disc drive, mounted in the terminal. Further, the cookie file storage unit 130 can store backup files of the cookie file in order to protect the cookie files from being unintentionally deleted, and to restore the cookie files based on the backup files when the cookie files are unintentionally deleted and/or damaged.

The input unit 140 can be a device, such as a keyboard, a mouse, etc., installed in the terminal to receive user's commands. Further, the input unit 140 can receive from a user the specification information of the module 200, such as the product number, the replacement period of time, or a usage frequency.

The display unit 150 can be a device, for example, a monitor connected to the terminal, to display the operation state and an output of the module management device 100. The display unit 150 can display the specification information and the operation state of the module 200, web pages provided by web servers (not shown), and so on.

The control unit 160 can control overall operations of the module management device 100. In particular, by referring to the replacement period of time of the module 200 included in the specification information of the cookie file stored in the cookie file storage unit 130, the control unit 160 can set up a detection period of time of the operation state of the module 200 and can control the detection unit 100 to detect the operation state of the module 200 based on the set detection period of time. The detection period of time can be set to the same as or shorter than the replacement period of time.

Further, the control unit 160 can send to the cookie file creation unit 120 the specification information of the module 200 inputted from a user through the input unit 140, and can display on the display unit 150 the specification information and the operation state of the module 200 of the cookie file stored in the cookie file storage unit 130.

Further, if the detection unit 110 detects the malfunction state of the module 200, the control unit 160 can control a browser (not shown) of the terminal to read a corresponding cookie file out of the cookie files stored in the cookie file storage unit 130, and can send the cookie file to a web server (not shown).

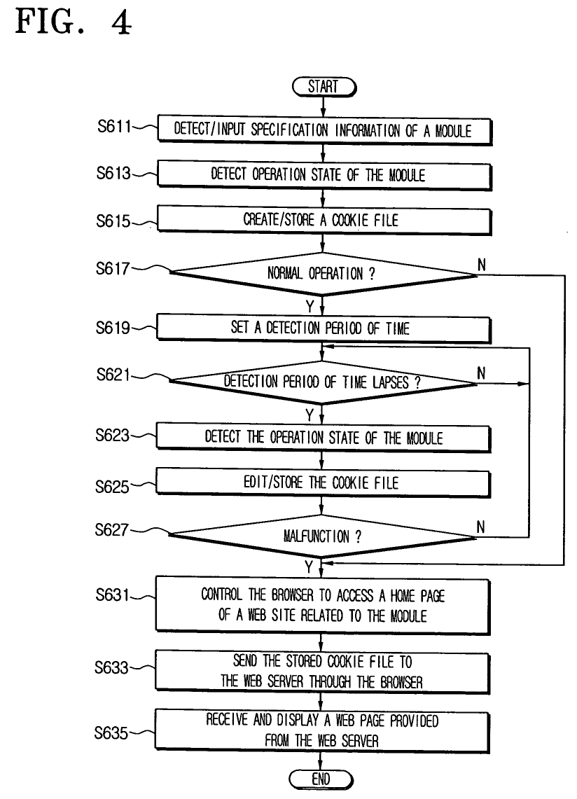

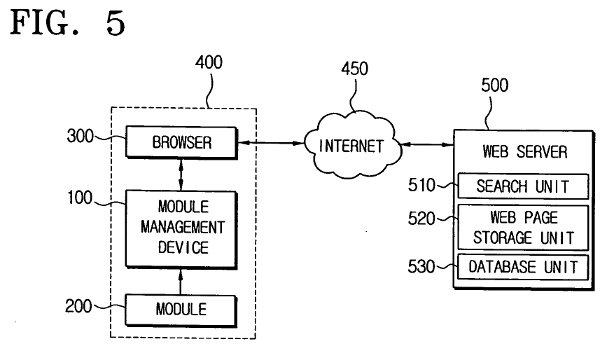

FIG. 4 is a flow chart illustrating a module management method of the module management device shown in FIG. 3 according to another embodiment of the present general inventive concept.

Referring to FIGS. 3 and 4, if a module, for example, the module 200, is newly installed in the terminal, the detection unit 110 can detect the specification information, such as the product number, the replacement period of time, etc., of the installed module 200, and can send the specification information to the cookie file creation unit 120 (S611).

On the other hand, the specification information can be directly inputted by a user through the input unit 140, and the inputted specification information can be sent to the cookie file creation unit 120 through the control unit 160. If a user directly inputs the specification information of the module 200, the user can input user information, such as an individual, a corporation, a government agency, etc., and the usage frequency of the module 200, such as a frequent usage, a regular usage, a often usage, etc., as well, and such information can be used to set a detection period of time to be later described.

Further, the detection unit 110 can detect the operation state of the installed module 200 and can send a detection result to the cookie file creation unit 120 and the control unit 160 (S613). In detail, the detection unit 110 detects whether the module 200 is in a normal operation state or in a malfunction state, or whether the malfunction state is caused by a run-out state of the module 200.

The cookie file creation unit 120 can create a cookie file having the specification information and the operation state of the module 200 sent in operations S611 and S613, and can store the created cookie file in the cookie file storage unit 130 (S615).

Further, the control unit 160 can decide whether the module 200 is in the normal operation state, based on the detection result of the operation state of the module 200 sent from the detection unit 110 (S617).

If the module 200 is decided to be in the normal operation state in operation S617, the installing of the module 200 and the creating of the cookie file for the management of the module 200 can be completed, so the module 200 can be managed according to a certain period of time after the module installation and the cookie file creation.

In an aspect of the present general inventive concept, the control unit 160 can refer to the replacement period of time out of the specification information of the cookie file stored in the cookie file storage unit 130 to set a detection period of time of the operation state of the module 200 (S619). At this time, the control unit 160 can set the detection period of time of the operation state of the module 200 same as or shorter than the replacement period of time of the module 200.

Further, when setting the detection period of time of the operation state, the control unit 160 can also reflect the user information, such as the individual, the corporation, or the government agency, and the usage frequency, such as the frequent usage, the regular usage, or the often usage, of the specification information included in the cookie file to determine the detection period of time of the operation state. For example, if the user information is set to the ‘corporation’ and the usage frequency is set to the ‘frequent usage,’ the control unit 160 can set the detection period of time to be shorter than a detection period of time in a case of the ‘individual’ and the ‘often’ usage set in the user information and the usage frequency, respectively.

If the control unit 160 decides that the detection period of time set in operation S619 lapses (S621), the control unit 160 can control the detection unit 110 to start its detection operation, and the detection unit 110 can detect the operation state of the module 200 and can send the detection result to the cookie file creation unit 120 and the control unit 160 (S623).

The cookie file creation unit 120 can read the cookie file, which has been created and stored in operation S615, from the cookie file storage unit 130, can edit the cookie file in order to reflect the operation state of the module 200 supplied in operation S623, and can store the edited cookie file in the cookie file storage unit 130 in operation S625. Here, the edited content is reflected even on backup data.

On the other hand, the control unit 160 can decide whether the module 200 is in the normal operation state based on the detection result of the operation state of the module 200 supplied in operation S623 from the detection unit 110 (S627).

If the control unit 160 decides in operation S627 that the module 200 is in the malfunction state, the control unit 160 can control the browser (not shown) installed in the terminal to be connected to the home page of the web site relating to the module 200 (S631). At the same time, the control unit 160 can display on the display unit 150 a message notifying that the module 200 is in the malfunction state.

Further, the browser sends the cookie file, which is stored in the cookie file storage unit 130, to the web server providing the web site relating to the module 200 (S633).

In an aspect of the present general inventive concept, based on the specification information and the operation state of the module 200, the web server can search for a web page to be sent, and can send the searched web page to the browser. The browser can receive the web page provided by the web server, and the received web page can be displayed on the display unit 150 (S635).

In another aspect of the present general inventive concept, the web server can refer to the product number of the specification information included in the cookie file to search for and provide a product service-related web page of the home page of the web site relating to the module 200. Further, if the module 200 is a consumable item, and the state information included in the cookie file indicates that the module 200 is in the malfunction state due to the ‘run-out’ state, the web server can refer to the product number of the specification information of the module 200 to search for and provide a module purchase web page of the home page of the web site relating to the module 200.

On the other hand, if the module 200 is decided in operation S617 to be in the malfunction state, the control unit 160 can directly carry out operation S631, and, if the module 200 is decided in operation S627 to be in the normal function state, the control unit 160 can perform operation S621, thereby detecting the operation state of the module 200 according to the detection period of time.

FIG. 5 is a block diagram illustrating a module management system configured by using the module management device of FIG. 3 according to another embodiment of the present general inventive concept. Referring to FIGS. 3 and 5, the module management system can be structured by connecting a web server 500 to a terminal 400 having the module management device 100, the module 200, and a browser 300 through the Internet 450.

The module management device 100 and the module 200 shown in FIG. 5 are the same as those shown in FIG. 3, so a detailed description on the module management device 100 and the module 200 will be omitted.

The browser 300 can be a unit used to search for various resources existing in the Internet and can be installed in the terminal 400.

The web server 500 can search for a web page based on a cookie file transferred from the terminal 400 through the Internet 450 and can send the searched web page to the terminal 400 through the Internet 450. The web server 500 performing such functions may have a search unit 510, a web page storage unit 520, and a database unit 530.

The search unit 510 can decide the web page to be transferred to the module management device 100, based on the specification information and the operation state of the module 200 included in the cookie file transferred from the module management device 100 through the Internet 450, and can search the web page storage unit 520 for the web page to be sent to the module management device 200. The searched web page can be sent to the module management device 100 through the Internet 450.

The web page storage unit 520 can store home pages of web sites relating to the module 200 and web pages that the home pages provide. Here, a home page may include a plurality of web pages.

The database unit 530 can store the specification information and the operation state of the module 200 included in the cookie file which has been transferred from the module management device 100, a web page history that users have visited, a service that users have been provided through the web pages, and so on.

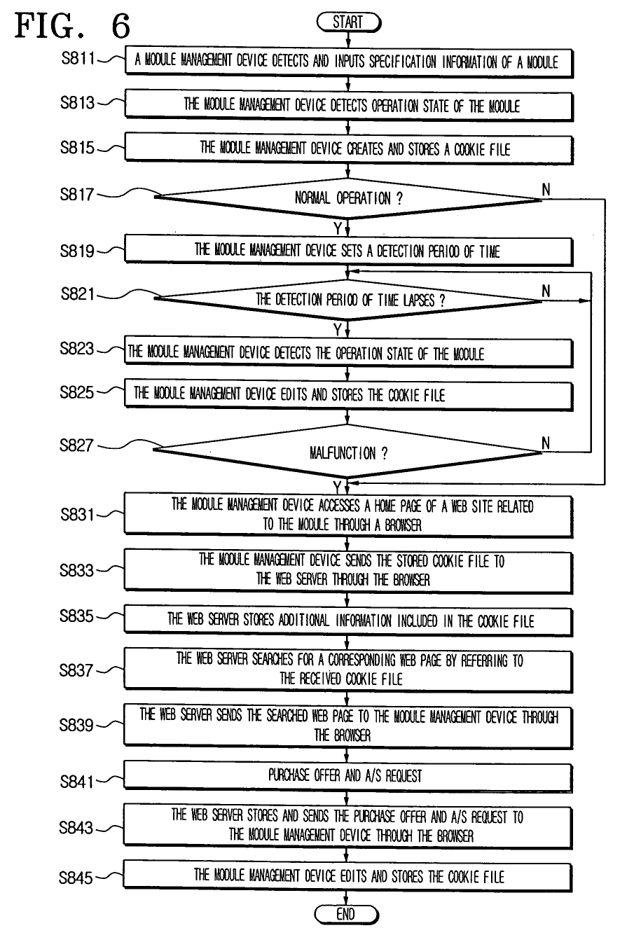

FIG. 6 is a flow chart illustrating a module management method of the module management system shown in FIG. 5 according to another embodiment of the present to the module management device 200.

Referring to FIGS. 3, 5, and 6, if the module 200 is newly installed in the terminal 400, the detection unit 110 of the module management device 100 can detect and send the specification information of the installed module 200 to the cookie file creation unit 120 (S811). Further, a user can directly input the specification information through the input unit 140 of the module management device 100, and the inputted specification information can be sent to the cookie file creation unit 120 through the control unit 160.

The detection unit 110 of the module management device 100 can detect the operation state of the installed module 200, and can send the detection result to the cookie file creation unit 120 and the control unit 160 (S813).

The cookie file creation unit 120 of the module management device 100 can create the cookie file including the specification information and the operation state of the module 200 sent in operations S811 and S813, and can store the created cookie file in the cookie file storage unit 130 (S815).

Further, the control unit 160 of the module management device 100 can decide whether the module 200 is in the normal operation state, based on the detection result of the operation state of the module 200 sent from the detection unit 110 (S817).

If the module 200 is decided to be in the normal operation state in operation S817, the installing of the module 200 and the creating of the cookie file for the management of the module 200 can be completed, and then the module management device 100 can manage the module 200 in a predetermined period of time.

In an aspect of the present general inventive concept, the control unit 160 of the module management device 100 can refer to the replacement period of time of the specification information of the cookie file stored in the cookie file storage unit 130 to set the detection period of time of the operation state of the module 200 (S819).

In this embodiment, if the control unit 160 of the module management device 100 decides that the detection period of time set in operation S819 lapses (S821), the control unit 160 can control the detection unit 110 to start detection operations, so that the detection unit 160 can detect the operation state of the module 200 and send a result of the detection to the cookie file creation unit 120 and the control unit 160 (S823).

The cookie file creation unit 120 of the module management device 100 can read from the cookie file storage unit 130 the cookie file created and stored in operation S815, can edit the cookie file by reflecting the operation state of the module 200 sent in operation S823, and can store the edited cookie file to the cookie file storage unit 130 again (S825). Here, the edited content can be reflected on the backup data as well.

On the other hand, the control unit 160 of the module management device 100 can decide whether the module 200 is in the normal operation state, based on the detection result of the operation state of the module 200 sent from the detection unit 110 in operation S823 (S827).

If the control unit 160 of the module management device 100 decides in operation S827 that the module 200 is in the malfunction state, the control unit 160 can control the browser 300 to access a home page of a web site, which has been provided by the web server to the terminal 400, relating to the module 200 (S831). At the same time, the control unit 160 of the module management device 100 can display on the display unit 150 a message notifying that the module is in the malfunction state.

Further, if there is a request from the web server 500, the browser 300 can automatically send to the web server 500 the cookie file stored in the cookie file storage unit 130 of the module management device 100 (S833).

The web server 500 can store the specification information of the module 200 and information on the operation state of the module 200 that are additional information included in the sent cookie file (S835).

Further, the search unit 510 of the web server 500 can search for a web page to be provided to the module management device 100 in operation S837, based on the specification information of the module 200 and the operation state information of the module 200 that are included in the cookie file sent in operation S833.

In detail, the search unit 510 of the web server 500 can search for a service (maintenance plan or warranty)-related web page of the home pages of the web site relating to the module 200 to be repaired, based on the product number of the specification information of the module 200 included in the cookie file. Further, if the module 200 is the consumable item, and the operation state information of the module 200 included in the cookie file indicates the malfunction state of the module 200 due to the ‘run-out’ state, the search unit 510 of the web server 500 can search for a module purchase web page included in the home page of the web site relating to the module 200 to be replaced with a new one, by referring to the product number of the specification information of the module 200.

The web server 500 can transfer to the browser 300 the web page searched for in operation S837, and the transferred web page can be displayed on the display unit 150 of the module management device 100 (S839).

If the user makes a purchase offer (purchase order) or a service request (or service order) for the module 200 through the web page displayed on the display unit 150 of the module management device 100, the requested particulars, such as the purchase order or the service order, can be sent to the web server 500 through the browser 300 (S841).

The web server 500 can store the requested particulars in the database unit 530 and can send the requested particulars and a processing result of the request to the module management device 100 through the browser 300 (S843).

The cookie file creation unit 120 of the module management device 100 can read the stored cookie file from the cookie file storage unit 130, can edit the cookie file by reflecting the requested particulars and the processing result of the request sent in operation S843, and can store the edited cookie file in the cookie file storage unit 130 (S845). The edited cookie file can be provided as history information if the module management device 100 is hooked up to the web server 500.

On the other hand, if the module 200 is decided in operation S817 to be in the malfunction state, operation S831 can be directly carried out, and, if the module 200 is decided in operation S827 to be in the normal operation state, operation S821 can be carried out, so that the operation state of the module 200 can be detected according to the detection period of time.

The specification information of the module 200, the state information of the module 200, the requested particulars, and the processing result of the request can be stored in the database unit 530 of the web server 500 in operations S835 and S843 and can be used when the web server 500 provides the user with additional services in the future.

Although descriptions have been made on the peripherals, such as printers or scanners, and consumables, such as printer toner or ink cartridges, as the module 200 to be managed, the present general inventive concept is not limited thereto. Therefore the present general inventive concept can be applied even in a case of updating and purchasing software, such as programs running in drivers and terminals to drive peripherals.

Further, there is no limitation on the kind of specification information additionally included and recorded in a cookie file. Therefore, the cookie file can include and record other additional information as well as the product number, the replacement period of time, and the usage frequency, and a module management device or a web server can read out and use such information.

As aforementioned, since the present general inventive concept can detect the specification information and operation state of a module mounted in a terminal, such as a personal computer, and directly receive necessary web pages from a web server providing a web site relating to the module by using information file, such as a cookie file, created based on the detections, the present general inventive concept can prevent inconvenience caused by attempts to search for and access desired web pages as well as inconvenience caused by searching for the module a user wants to purchase.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A module management device to manage a module mounted in a terminal in which a browser is installed, comprising:
a detection unit to detect an operation state of the module;
a file creation unit to create an information file including specification information and the operation state of the module;
a file storage unit to store the created information file; and
a control unit to control the detection unit to detect the operation state of the module according to the specification information, and to connect the browser to a web server providing a web site relating to the module if the detection unit detects a malfunction state of the module, to control the browser to automatically transfer to the web server the information file stored in the file storage unit if there is a request from the web server, and to receive a web page provided by the web server based on the information file.

2. The module management device of claim 1, wherein the information file is a cookie file.

3. The module management device of claim 1, wherein the detection unit detects the specification information of the module, and the file creation unit creates the information file including the specification information detected in the detection unit.

4. The module management device of claim 1, further comprising:
a display unit to display at least one of the specification information, the operation state, and the web page.

5. The module management device of claim 1, wherein the specification information includes a replacement period of time of the module, and the control unit sets a detection period of time of the detection unit according to the replacement period of time and controls the detection unit to detect the operation state according to the set detection period of time.

6. The module management device of claim 1, wherein the web server sends to the browser a module purchase web page provided from the home pages of the web site relating to the module if the operation state of the module included in the information file received by the web server indicates that the module is in the malfunction state since the module is run out.

7. A module management system, comprising:
a module management device having a terminal, a module mounted in the terminal, and a browser installed in the terminal, to create an information file including specification information and an operation state of the module, and to connect the browser to a web site relating to the module; and
a web server to request the browser to send the information file, and to send to the module management device through the browser a web page provided from a home page of the web site relating to the module.

8. The module management system of claim 7, wherein the information file is a cookie file.

9. The module management system of claim 7, wherein the module management device comprises:
a detection unit to detect the operation state of the module;
a file creation unit to create the information file;
a file storage unit to store the created information file; and
a control unit to control the detection unit to detect the operation state of the module according to the specification information, and to control the browser to be connected to the web server if the detection unit detects the malfunction state of the module.

10. The module management system of claim 9, wherein the module management device comprises a display unit to display at least one of the specification information, the operation state, and the web page.

11. The module management system of claim 7, wherein the web server comprises:
a web page storage unit to store the home page of the web site relating to the module, and the web page provided in the home page; and
a search unit for to decide the web page to be sent to the module management device by referring to the information file, and to search the web page storage unit for the web page to be sent to the module management device.

12. The module management system of claim 11, wherein the search unit decides sending of a module purchase web page provided from the home page of the web site relating to the module if the operation state of the module included in the information file indicates the malfunction state of the module since the module is run out.

13. A module management method of a module management system having a module management device to detect a malfunction state of a module mounted in a terminal and a web server to provide a web site relating to the module, the module management method comprising:
detecting an operation state of the module in the module management device;
creating an information file including specification information and an operation state of the module in the module management device;
sending the information file to the web server if the module management device detects the malfunction state of the module; and
sending a certain web page to the module management device by the web server referring according to the information file received by web server.

14. The module management method of claim 13, wherein the information file is a cookie file.

15. The module management method of claim 13, wherein the detecting of the operation state of the module comprises detecting the specification information of the module.

16. The module management method of claim 13, further comprising displaying at least one of the specification information, the operation state, and the certain web page.

17. The module management method of claim 13, wherein the specification information includes a replacement period of time of the module, and the detecting of the operation state of the module comprises detecting the operation state of the module according to a detection period of time set based on the replacement period of time.

18. The module management method of claim 13, wherein the web server sends to the module management device a module purchase web page provided from the home page of the web site relating to the module if the operation state of the information file received by the web server indicates that the module is in the malfunction state since the module is run out.

19. A module management system having a module, comprising:
a module management device to detect an operation state of the module, to create an information file corresponding to specification information and the operation state of the module, to output the information file according to a characteristic of the operation state of the module, to receive a home page of a web site to the module, and to automatically access the home page of the web site and place an order relating to the module through the received home page.

20. The module management system of claim 19, wherein the module management comprises:
a detection unit to detect the operation state of the module;
a file creation unit to create the information file including the operation state and the specification information of the module; and
a control unit to automatically output the information through Internet, and to receive the home page of the web site through Internet.
